(19) United States
(12) Patent Application Publication
(10) Pub. No.: US 2026/0150159 A1
(43) Pub. Date: May 28, 2026

(54) HEATING ASSEMBLY, AND AEROSOL GENERATION DEVICE

(71) Applicant: SHENZHEN FIRST UNION TECHNOLOGY CO., LTD., Shenzhen, Guangdong (CN)

(72) Inventors: Minghua CHENG, Shenzhen, Guangdong (CN); Yongsheng ZHENG, Shenzhen, Guangdong (CN); Guimin CHEN, Shenzhen, Guangdong (CN); Zuqiang QI, Shenzhen, Guangdong (CN); Jiamao LUO, Shenzhen, Guangdong (CN); Lu ZHOU, Shenzhen, Guangdong (CN); Baoling LEI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/121,278

(22) PCT Filed: Oct. 13, 2023
(86) PCT No.: PCT/CN2023/124457

§ 371 Date: Apr. 15, 2025

(30) Foreign Application Priority Data
Oct. 15, 2022 (CN) 202211275451.7

(51) Int. Cl. H05B 6/10; A24F 40/20; A24F 40/465

(52) U.S. Cl. CPC H05B 6/108; A24F 40/465; A24F 40/20

(57) ABSTRACT

A heating assembly and an aerosol generation device are provided. The heating assembly includes a tubular body having a cavity. A near end of the tubular body is open and used for allowing an aerosol forming substrate to enter the cavity. The tubular body has a heating area and a blank area. A part of the heating area and a part of the blank area are arranged to surround a periphery of the aerosol forming substrate. A temperature and/or temperature rising speed of the blank area is lower than a temperature and/or temperature rising speed of the heating area. A near end of the heating area is closer to the near end of the tubular body than a far end thereof. The far end of the heating area and a far end of the tubular body are spaced apart from each other in a longitudinal direction of the tubular body.

### CROSS-REFERENCE TO RELATED APPLICATIONS

This application claims priority to Chinese Patent Application No. 202211275451.7, filed with the China National Intellectual Property Administration on Oct. 15, 2022 and entitled “HEATING ASSEMBLY, AND AEROSOL GENERATION DEVICE”, which is incorporated herein by reference in its entirety.

### TECHNICAL FIELD

Embodiments of this application relate to the field of aerosol generation technologies, and in particular, to a heating assembly and an aerosol generation device.

### BACKGROUND

An existing aerosol generation device includes a heating assembly inside. The heating assembly heats an aerosol generation product, to generate an aerosol for a user for using or inhalation. However, after the existing aerosol generation product is heated by the heating assembly, oil leaks out, polluting the inside of the aerosol generation device.

### SUMMARY

Embodiments of this application provide a heating assembly and an aerosol generation device, which can reduce pollution caused by an aerosol generation product.

An embodiment of this application provides a heating assembly, including:
a tubular body, having a cavity formed therein, where a near end of the tubular body is open and is used for allowing an aerosol forming substrate in an aerosol generation product to enter the cavity; and
the tubular body has a heating area and a blank area, and at least a part of the heating area and at least a part of the blank area are arranged to surround a periphery of the aerosol forming substrate, where
a temperature and/or a temperature rising speed of the blank area is lower than a temperature and/or a temperature rising speed of the heating area; and
a near end of the heating area is closer to the near end of the tubular body than a far end of the heating area, the far end of the heating area and a far end of the tubular body are spaced apart from each other in a longitudinal direction of the tubular body, and the blank area is located between the far end of the heating area and the far end of the tubular body.

An embodiment of this application provides a heating assembly, including:
a tubular body, having a cavity formed therein, where a near end of the tubular body is open and is used for allowing a part of an aerosol generation product to enter the cavity, and the tubular body includes a heating area and a blank area; and
a heating element, at least partially arranged in the heating area, and configured to heat an aerosol forming substrate in the aerosol generation product, to generate an aerosol, where the aerosol forming substrate enters the heating area from a near end of the heating area;
a temperature of the blank area is lower than a temperature of the heating area, or a temperature rising speed of the blank area is lower than a temperature rising speed of the heating area, or heating efficiency of the blank area for the aerosol forming substrate is lower than heating efficiency of the heating area for the aerosol forming substrate; and
the blank area is provided with a positioning portion, used for determining a boundary of at least a part of the heating element.

An embodiment of this application provides a heating assembly, including:
a tubular body, having a cavity formed therein, where a near end of the tubular body is open and is used for allowing a part of an aerosol generation product to enter the cavity, and the tubular body includes a heating area and a blank area; and
a heating element, at least partially arranged in the heating area, and configured to heat an aerosol forming substrate in the aerosol generation product, to generate an aerosol, where the aerosol forming substrate enters the heating area from a near end of the heating area;
a temperature of the blank area is lower than a temperature of the heating area, or a temperature rising speed of the blank area is lower than a temperature rising speed of the heating area, or heating efficiency of the blank area for the aerosol forming substrate is lower than heating efficiency of the heating area for the aerosol forming substrate; and
the blank area includes a retaining location, used for clamping the tubular body during processing of the heating assembly.

An embodiment of this application provides a heating assembly, including:
a tubular body, having a cavity formed therein, where a near end of the tubular body is open and is used for allowing an aerosol forming substrate in an aerosol generation product to enter the cavity; and
the tubular body has a heating area and a blank area, and the heating area is used for heating the aerosol forming substrate, to generate an aerosol, where the aerosol forming substrate enters the heating area from a near end of the heating area; a temperature of the blank area is lower than a temperature of the heating area, or a temperature rising speed of the blank area is lower than a temperature rising speed of the heating area, or heating efficiency of the blank area for the aerosol forming substrate is lower than heating efficiency of the heating area for the aerosol forming substrate; and
at least a part of the aerosol forming substrate corresponding to the blank area is clamped.

An embodiment of this application provides an aerosol generation device, including a shell and the heating assembly, where an accommodating cavity is formed in the shell, and is for accommodating the heating assembly; and an insertion port is provided on the shell, and the aerosol forming substrate passes through the insertion port and then enters the cavity.

According to the foregoing heating assembly and aerosol generation device, a far end of a heating area and a far end of a tubular body are spaced apart from each other, and a blank area is at least partially located between the far end of the heating area and the far end of the tubular body, so that a far end of an aerosol forming substrate is relatively at a relatively low ambient temperature, or oil that leaks out from the aerosol forming substrate is retained by the far end of the tubular body, thereby preventing pollution caused by oil leakage when an aerosol generation product is baked.

### BRIEF DESCRIPTION OF THE DRAWINGS

One or more embodiments are exemplarily described with reference to the corresponding figures in the drawings and the descriptions are not to be construed as limiting the embodiments. Components in the drawings that have same reference numerals are represented as similar components and unless otherwise particularly stated, the figures in the drawings are not drawn to scale.

FIG. 1 is a schematic diagram of an aerosol generation device according to an embodiment of this application;

FIG. 2 is a cross-sectional view of a heating assembly and an aerosol generation product according to an embodiment of this application;

FIG. 3 is a cross-sectional view of a heating assembly according to an embodiment of this application;

FIG. 4 is a schematic diagram of a second tubular body according to an embodiment of this application;

FIG. 5 is a cross-sectional view of a tubular body according to an embodiment of this application;

FIG. 6 is a schematic diagram of a tubular body according to an embodiment of this application;

FIG. 7 is an exploded view of a tubular body according to an embodiment of this application;

FIG. 8 is an exploded view of a tubular body according to another embodiment of this application;

FIG. 9 is a schematic diagram of cooperation between a jig and a tubular body according to an embodiment of this application; and

FIG. 10 is a cross-sectional view of cooperation between a jig and a tubular body according to an embodiment of this application.

In the drawings:
1: aerosol generation product; 11: aerosol forming substrate; 12: cooling section; 13: mouthpiece;
2: heating assembly; 21: tubular body; 211: positioning groove; 212: first tubular body; 213: second tubular body; 22: insulating layer; 23: heating element; 231: second notch; 24: electrode;
25: protective layer; 26: heating area; 27: clamping member; 271: inclined guiding surface; 272: fixing portion; 273: protruding portion; 28: first notch; 29: blank area;
3: insertion port;
4: jig; 41: first support portion; 411: first connecting handle; 412: convex tooth; 42: second support portion; 421: second connecting handle; and 43: stop portion.

### DETAILED DESCRIPTION

The following clearly and completely describes the technical solutions in the embodiments of this application with reference to the drawings in the embodiments of this application. Apparently, the described embodiments are some embodiments of this application rather than all of the embodiments. All other embodiments obtained by a person skilled in the art based on the embodiments of this application without creative efforts shall fall within the protection scope of this application.

In this application, terms “first”, “second”, and “third” are used merely for the purpose of description, and shall not be construed as indicating or implying relative importance or implying a quantity of indicated technical features. All directional indications (such as up, down, left, right, front, back, . . . ) in the embodiments of this application are only used to explain relative positional relationship, moving conditions, or the like between components in a specific posture (as shown in the drawings). If the specific posture changes, the directional indications also change accordingly. In addition, the terms “include”, “have”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

“Embodiment” mentioned in this specification means that particular features, structures, or characteristics described with reference to the embodiment may be included in at least one embodiment of this application. The term appearing at different locations of this specification may not refer to the same embodiment or an independent or alternative embodiment that is mutually exclusive with another embodiment. It shall be explicitly and implicitly understood by a person skilled in the art that the embodiments described herein may be combined with other embodiments.

It should be noted that, when an element is referred to as “being fixed to” another element, the element may be directly on the another element, or an intervening element may be present. When an element is considered to be “connected to” another element, the element may be directly connected to the another element, or one or more intervening elements may be present. Terms “vertical”, “horizontal”, “left”, and “right” and similar expressions used in this specification are merely used for the purpose of description, and are not a unique implementation.

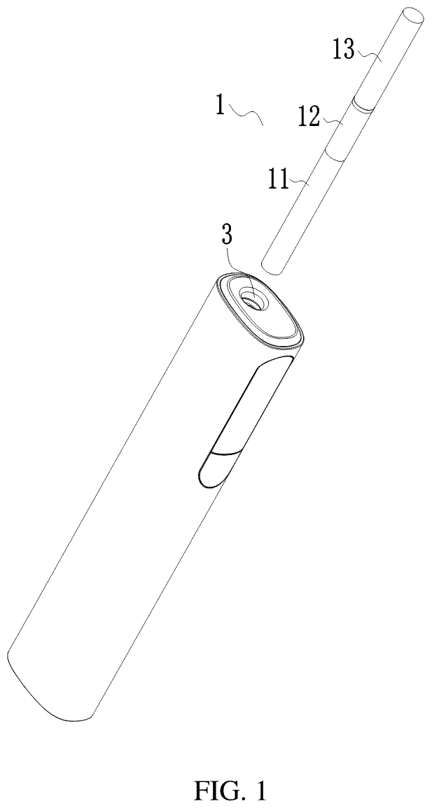

Referring to FIG. 1, an embodiment of this application provides an aerosol generation device. The device may be configured to heat an aerosol generation product 1, so that the aerosol generation product 1 volatilizes an aerosol for inhalation.

As used in this specification, the term “aerosol generation product” refers to a product including an aerosol forming substrate. When being heated, the aerosol forming substrate releases a volatile compound that can form the aerosol. The “aerosol generation product” refers to the product including the aerosol forming substrate. The aerosol forming substrate intends to release, through heating rather than combustion, the volatile compound that can form the aerosol. Compared with an aerosol generated through combustion or pyrolytic degradation of the aerosol forming substrate, the aerosol formed through heating of the aerosol forming substrate may include fewer components that are known to be harmful. In an embodiment, the aerosol generation product may be removably coupled to the aerosol generation device. The aerosol generation product may be disposable or reusable.

The aerosol forming substrate may be a solid aerosol forming substrate. Alternatively, the aerosol forming substrate may include a solid component and a liquid component. The aerosol forming substrate may include tobacco. The aerosol forming substrate may include a tobacco-containing material, where the tobacco-containing material includes a volatile tobacco aroma compound released from the substrate during heating. The aerosol forming substrate may include a non-tobacco material. The aerosol forming substrate may include a tobacco-containing material and a non-tobacco-containing material.

An outer diameter of the aerosol generation product 1 may range from about 5 mm to about 12 mm, for example, about 5.5 mm to about 8 mm. In an embodiment, the outer diameter of the aerosol generation product 1 is 6 mm +/−10%.

A total length of the aerosol generation product 1 may range from about 25 mm to about 100 mm. The total length of the aerosol generation product 1 may range from about 30 mm to about 100 mm. In an embodiment, a total length of an aerosol forming substrate 11 accounts for ½ of the total length of the aerosol generation product 1. In an embodiment, the total length of the aerosol generation product 1 is about 84 mm. In an embodiment, the total length of the aerosol forming substrate 11 is about 42 mm. In an embodiment, the total length of the aerosol forming substrate 11 is about 34 mm.

Referring to FIG. 1, the aerosol generation product 1 includes a mouthpiece 13, a cooling section 12, and the aerosol forming substrate 11. The cooling section 12 is located between the mouthpiece 13 and the aerosol forming substrate 11. The mouthpiece 13 is located outside the aerosol generation device, for a user to hold in mouth.

As used in this specification, the term “aerosol generation device” is a device that joins or interacts with the aerosol generation product 1 to form an inhalable aerosol. The aerosol generation device interacts with the aerosol forming substrate to generate the aerosol. An electrically operated aerosol generation device is a device including one or more components for supplying energy from, for example, a power supply assembly to heat an aerosol forming substrate to generate an aerosol.

The aerosol generation device may be described as a heating aerosol generation device, which is an aerosol generation device including a heating assembly 2. The heating assembly 2 is configured to heat the aerosol forming substrate of the aerosol generation product 1 to generate the aerosol.

The aerosol generation device may include a power supply assembly configured to supply power to the heating assembly 2. The power supply assembly may include any suitable power supply, for example, a DC source, such as a battery. In an embodiment, the power supply is a lithium-ion battery. Alternatively, the battery may be a nickel metal hydride battery, a nickel-cadmium battery, or a lithium-based battery, such as a lithium cobalt, lithium iron phosphate, lithium titanate, or lithium polymer battery.

The aerosol generation device may include a circuit board configured to control power supply from the power supply to the heating assembly 2. The circuit board may be provided with one or more microprocessors or microcontrollers.

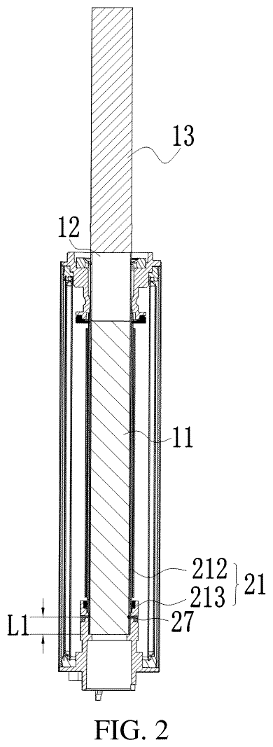

Referring to FIG. 1 and FIG. 2, an insertion port 3 may be provided on the aerosol generation device, so that the aerosol generation product 1 is partially inserted into the aerosol generation device through the insertion port 3, and the aerosol forming substrate 11 inside the aerosol generation device can be heated by the heating assembly 2.

The heating assembly 2 may include at least one external heating assembly. As used in this specification, the term “external heating assembly” refers to a heating assembly located on the outside of the aerosol generation product during assembly of an aerosol generation system including the aerosol generation product 1. In an embodiment, the at least one external heating assembly is distributed in a longitudinal direction of the aerosol generation product 1. Specifically, referring to FIG. 2, the at least one external heating assembly includes a tubular body 21, where the tubular body 21 extends in a length direction of the aerosol generation product 1 (that is, longitudinally extends) and is arranged on a periphery of the aerosol generation product 1. In an embodiment, the heating assembly 2 includes a plurality of external heating assemblies, configured to independently heat different longitudinal intervals of the aerosol forming substrate 11. As used in this specification, the term “independent heating” means that two or more heating assemblies have different one or more of heating start time, heating end time, heating duration, a heating power, a target heating temperature, a maximum heating temperature, and the like.

Referring to FIG. 2, the tubular body 21 has a cavity formed therein. A near end of the tubular body 21 is open and is used for allowing the aerosol forming substrate 11 to enter the cavity. The mouthpiece 13 of the aerosol generation product 1 is located at a near end of the aerosol generation product 1, and the bottom of the aerosol forming substrate 11 is located at a far end of the aerosol generation product 1.

The tubular body 21 has a heating area 26 and a blank area 29. The heating area 26 has a relatively high temperature, or has a relatively fast temperature rising speed, or has relatively large heating efficiency for heating of the aerosol forming substrate 11. At least a part of the heating area 26 surrounds the aerosol forming substrate 11, to heat at least a part of the aerosol forming substrate 11, so that the aerosol forming substrate 11 generates an aerosol. A near end of the heating area 26 is closer to the near end of the tubular body 21 than a far end of the heating area 26, and the aerosol forming substrate 11 enters the heating area 26 from the near end of the heating area 26. In an embodiment, a temperature of the blank area 29 is lower than a temperature of the heating area 26, or a temperature rising speed of the blank area 29 is lower than a temperature rising speed of the heating area 26, or heating efficiency of the blank area 29 for the aerosol forming substrate 11 is lower than heating efficiency of the heating area 26 for the aerosol forming substrate 11. Compared with the heating area 26, the blank area 29 helps to reduce an amount of oil that leaks out from the aerosol forming substrate 11 or a speed at which oil leaks out from the aerosol forming substrate 11. In an embodiment, at least a part of the blank area 29 is arranged to surround a periphery of the aerosol forming substrate 11, and a temperature of the part of the blank area 29 is lower than 160° C., so that the aerosol forming substrate 11 surrounded by the part of the blank area 29 is relatively in a low-temperature environment, and an aerosol cannot be generated or oil cannot leak out.

Because of existence of the blank area 29, the heating area 26 occupies only a part of the tubular body 21.

Based on this, in an optional implementation solution, one or more heating areas may be provided, and the tubular body located in the heating area generates heat through electromagnetism. Specifically, the tubular body located in the heating area includes a sensor. When the sensor is located in a fluctuating electromagnetic field, an eddy current caused in the sensor causes the sensor to heat.

As used in this specification, the term “sensor” refers to a material that can convert electromagnetic energy into heat. When the sensor is located in the fluctuating electromagnetic field, the eddy current caused in the sensor causes the sensor to heat. The sensor may be designed to join with the electrically operated aerosol generation device including a magnetic field generator. The magnetic field generator generates the fluctuating electromagnetic field, to heat the sensor located in the fluctuating electromagnetic field. During use, the sensor is located in the fluctuating electromagnetic field generated by the magnetic field generator. When the tubular body includes the sensor, the aerosol generation device may include the magnetic field generator that can generate the fluctuating electromagnetic field and the power supply connected to the magnetic field generator. The magnetic field generator may include one or more induction coils that generate the fluctuating electromagnetic field. The one or more induction coils may surround the sensor. In an embodiment, the aerosol generation device can generate a fluctuating electromagnetic field ranging from 1 MHz to 30 MHz, for example, 2 MHz to 10 MHz, such as 5 MHz to 7 MHz. In an embodiment, the aerosol generation device can generate a fluctuating electromagnetic field with field strength (H field) ranging from 1 kA/m to 5 kA/m, for example, 2 kA/m to 3 kA/m, such as being 2.5 kA/m. In an embodiment, the sensor may include a metal or carbon. In an embodiment, the sensor may include a ferro magnetic material, for example, ferrite, ferro magnetic steel, or stainless steel. A suitable sensor may be aluminum or include aluminum. In an embodiment, the sensor may be formed by 400 series stainless steel. The 400 series stainless steel is, for example, 410 grade, 420 grade, or 430 grade stainless steel. When the sensor is located in an electromagnetic field having a similar frequency and field strength value, different materials consume different amounts of energy. Therefore, parameters of the sensor, for example, a material type, a length, a width, and a thickness, may all be changed to provide known required power consumption in the electromagnetic field.

Further, the magnetic field generator includes one or more induction coils. The induction coil is arranged on a periphery of the tubular body and surrounds only a part of the tubular body. In an embodiment, the heating area 26 is an area surrounded by the induction coil, and the blank area 29 is an area not surrounded by the induction coil. In another embodiment, the heating area 26 is located in an area with large fluctuation strength/a high fluctuation frequency of a magnetic field, and the blank area 29 is located in an area with small fluctuation strength/a low fluctuation frequency of the magnetic field. In still another embodiment, the tubular body 21 corresponding to the blank area 29 and the tubular body 21 corresponding to the heating area 26 have different materials. For example, a magnetic induction coefficient of the tubular body 21 of the heating area 26 is greater than a magnetic induction coefficient of the tubular body 21 of the blank area 29. In conclusion, the temperature and/or the temperature rising speed and/or the heating efficiency of the blank area 29 is lower than the temperature and/or the temperature rising speed and/or the heating efficiency of the heating area 26.

In another optional implementation, one or more heating areas 26 may be provided, and the heating assembly 2 further includes one or more heating elements 23. A heating element 23 is arranged in a corresponding heating area 26, and is configured to heat the tubular body 21 corresponding to the heating area 26, and then heat the aerosol forming substrate 11 through the tubular body 21 of the area 26. Alternatively, the heating element 23 directly heats the aerosol forming substrate 11 through conduction or radiation.

In an embodiment, the heating element 23 may include a resistance material, and when the heating element 23 is powered on, Joule heat is generated by using the resistance material. A suitable resistance material includes, but is not limited to, a semiconductor such as a doped ceramic, a conductive ceramic (for example, molybdenum disilicide), carbon, graphite, a metal, a metal alloy, and a composite material made of a ceramic material and a metal material. This type of composite material may include a doped or non-doped ceramic. An example of a suitable doped ceramic includes doped silicon carbide. Examples of a suitable metal include titanium, zirconium, tantalum, and platinum-group metals. Examples of a suitable metal alloy include stainless steel, constantan, a nickel-containing alloy, a cobalt-containing alloy, a chromium-containing alloy, an aluminum-containing alloy, a titanium-containing alloy, a zirconium-containing alloy, a hafnium-containing alloy, a niobium-containing alloy, a molybdenum-containing alloy, a tantalum-containing alloy, a tungsten-containing alloy, a tin-containing alloy, a gallium-containing alloy, a manganese-containing alloy, an iron-containing alloy, a nickel-iron-cobalt-based super alloy, an iron-aluminum-based alloy, and an iron-manganese-aluminum-based alloy.

Further, a resistance value of the heating element 23 may range from 0.48 Ω to 1.53 Ω. Specifically, the resistance value may be 0.98 Ω, 0.99 Ω, 1.01 Ω, 1.03 Ω, or the like.

In another embodiment, the heating element 23 may include a sensor, which may heat in a fluctuating electromagnetic field.

In still another embodiment, the heating element 23 may include an infrared electrothermal coating. The infrared electrothermal coating may be coated on an outer surface of the tubular body 21. Preferably, the tubular body 21 in this case may be transparent to an infrared ray. For example, the tubular body 21 may be made of transparent quartz. Certainly, it is not excluded that the infrared electrothermal coating may be coated on an inner surface of the tubular body 21. The infrared electrothermal coating can generate heat energy when the heating element 23 is powered on, to generate an infrared ray of a specific wave length, for example, a far infrared ray ranging from 8 μm to 15 μm. When the wave length of the infrared ray matches an absorption wave length of the aerosol forming substrate, energy of the infrared ray is easy to be absorbed by the aerosol forming substrate. In this implementation of this application, the wave length of the infrared ray is not limited. The infrared ray may be an infrared ray ranging from 0.75 μm to 1000 μm, and optionally, may be a far infrared ray ranging from 1.5 μm to 400 μm. Optionally, the infrared electrothermal coating is formed through full stirring of far-infrared electrothermal ink, ceramic powder, and an organic binder, then is uniformly printed on an outer surface of a base body, and then is dried and solidified for a particular period of time. A thickness of the infrared electrothermal coating ranges from 30 μm to 50 μm. Certainly, the infrared electrothermal coating may alternatively be formed through mixing and stirring of tin tetrachloride, tin oxide, antimony trichloride, titanium tetrachloride, and anhydrous copper sulfate at a particular ratio, and then is coated on the outer surface of the base body. Alternatively, the infrared electrothermal coating is one of a silicon carbide ceramic layer, a carbon fiber composite layer, a zirconium-titanium oxide ceramic layer, a zirconium-titanium nitride ceramic layer, a zirconium-titanium boride ceramic layer, a zirconium-titanium carbide ceramic layer, an iron oxide ceramic layer, an iron nitride ceramic layer, an iron boride ceramic layer, an iron carbide ceramic layer, a rare earth oxide ceramic layer, a rare earth nitride ceramic layer, a rare earth boride ceramic layer, a rare earth carbide ceramic layer, a nickel-cobalt oxide ceramic layer, a nickel-cobalt nitride ceramic layer, a nickel-cobalt boride ceramic layer, a nickel-cobalt carbide ceramic layer, or a high silicon molecular sieve ceramic layer. The infrared electrothermal coating may alternatively be an existing coating made of another material.

In an optional example, the heating element 23 includes a heating coil, an etched mesh, a metal sleeve, or the like wound around or sleeved on a periphery of the heating area 26. In another optional example, the heating element 23 includes a heating coil, an etched mesh, a metal sleeve, or the like at least partially embedded in the tubular body 21 corresponding to the heating area 26. In another optional example, the heating element 23 includes a heating film layer coated in the heating area 26 of the tubular body 21 by using a paste.

In the embodiment in which the heating element 23 includes the heating coil, the etched mesh, or the metal sleeve arranged in the heating area 26, the heating element 23 may be directly electrically connected to a lead wire or a conductive terminal, and then is electrically connected to the power supply assembly through the lead wire or the conductive terminal. In other words, the heating assembly 2 does not need to be provided with an electrode 24 configured to electrically connect the lead wire (or the conductive terminal) to the heating element 23. In this case, compared with the heating area 26, the blank area 29 lacks at least the heating element 23. For example, if a heat conducting layer or a radiation layer for increasing heat conduction efficiency or improving heat radiation efficiency may further be provided on the tubular body 21 of the heating area 26 to improve the heating efficiency of the heating area 26 for the aerosol forming substrate 11, compared with the heating area 26, the blank area 29 further lacks the heat conducting layer or the radiation layer.

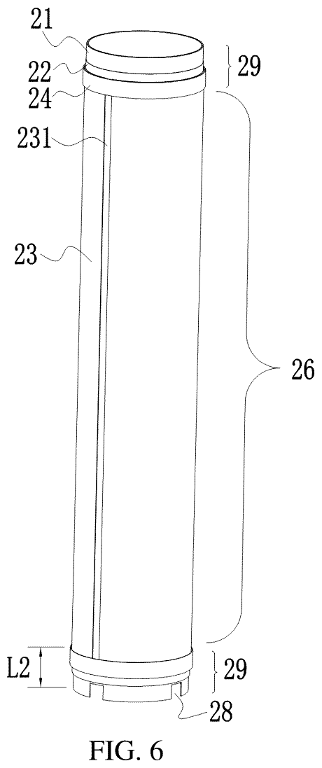

In the embodiment in which the heating element 23 includes the resistance material to generate Joule heat when the heating element 23 is powered on, or in the embodiment in which the heating element 23 includes the infrared electrothermal coating to generate heat energy when the heating element 23 is powered on, the heating assembly further includes an electrode 24, where the electrode 24 is configured to electrically connect to the corresponding heating element 23, to provide electric energy for heating of the corresponding heating element 23. In an embodiment, referring to FIG. 6, a current in the heating element 23 may flow in the heating element 23 in a longitudinal direction of the tubular body 21. Therefore, the electrode 24 includes a near end electrode and a far end electrode arranged in pairs, where the near end electrode is connected to a near end of the corresponding heating element 23, and the far end electrode is electrically connected to a far end of the corresponding heating element 23. In an example, the near end electrode at least partially overlaps with the near end of the heating area 26, and an overlapping location defines at least a near end of a corresponding top blank area (to be mentioned below). In other words, the near end electrode may be at least partially located in the top blank area. In a specific embodiment, the electrode 24 has relatively low resistance, so that the heating element 23 overlapping with the electrode 24 is almost short-circuited by the electrode 24. Therefore, the near end of the corresponding heating area 26 may be defined by a far end of the near end electrode, or a far end of the corresponding top blank area may be defined by the far end of the near end electrode. In another example, the far end electrode at least partially overlaps with the far end of the heating area 26, and an overlapping location defines at least a near end of a corresponding bottom blank area (to be mentioned below). In other words, the far end electrode may be at least partially located in the bottom blank area. In a specific embodiment, the electrode 24 has relatively low resistance, so that the heating element 23 overlapping with the electrode 24 is almost short-circuited by the electrode 24. Therefore, the far end of the corresponding heating area 26 may be defined by a near end of the far end electrode, or a near end of the corresponding bottom blank area may be defined by the near end of the far end electrode. Further, if only one heating element 23 is provided and two upper and lower ends of the heating element 23 each are connected to an electrode 24 so that a longitudinal current exists in the heating element 23, upper and lower boundaries of the heating area 26 are defined by the far end of the near end electrode and the near end of the far end electrode.

In another optional embodiment, one or more blank areas 29 are provided, where one blank area 29 is a bottom blank area, the bottom blank area is located between the far end of the heating area 26 and a far end of the tubular body 21, and the far end of the heating area 26 and the far end of the tubular body 21 are spaced apart from each other by the bottom blank area.

In a further embodiment, a longitudinal spacing between the far end of the heating area 26 and the far end of the tubular body 21 ranges from 1 mm to 12 mm, for example, may range from 1 mm to 5 mm, and preferably, is 3 mm; or may range from 6 mm to 12 mm. Alternatively, a longitudinal length L2 of the bottom blank area may range from 1 mm to 12 mm, for example, may range from 1 mm to 5 mm, and preferably, is 3 mm; or may range from 6 mm to 12 mm.

In an embodiment in which the heating element 23 and the electrode 24 are provided, the electrode 24 has relatively high resistance, and the electrode 24 is directly connected to the heating element 23. Therefore, the tubular body 21 corresponding to the electrode 24 also has a relatively high temperature, or has a relatively fast temperature rising speed, or has relatively high heating efficiency for the aerosol forming substrate. Therefore, an area corresponding to the electrode 24 belongs to the heating area 26, so that the far end of the corresponding heating area 26 may be defined by the far end of the far end electrode, and the bottom blank area is limited between the far end of the far end electrode and the far end of the tubular body 21.

Based on this, in a more further embodiment, the far end of the far end electrode and the far end of the tubular body 21 are spaced apart from each other, and a spacing ranges from 0.01 mm to 12 mm.

In still another embodiment in which the heating element 23 and the electrode 24 are provided, the blank area 29 further includes a top blank area. In an embodiment, the top blank area surrounds the aerosol forming substrate 11 of the aerosol generation product 1. In a specific example, a near end of the top blank area is flush with a near end of the aerosol forming substrate 11. In another embodiment, the top blank area surrounds the cooling section 12 of the aerosol generation product 1. In a specific example, a far end of the top blank area is flush with the near end of the aerosol forming substrate 11. In still another embodiment, one part of the top blank area surrounds the aerosol forming substrate 11, and the other part of the top blank area surrounds the cooling section 12.

In an embodiment, the top blank area is at least partially located between the far end of the near end electrode and the near end of the tubular body. In another embodiment, the top blank area may be located between a near end of the near end electrode and the near end of the tubular body. In another embodiment, the top blank area may be located between a near end of the heating element 23 and the near end of the tubular body.

A longitudinal extension length of the top blank area may be different from a longitudinal extension length of the bottom blank area. It may be understood that, it is optional rather than mandatory that the longitudinal extension length of the top blank area may be different from the longitudinal extension length of the bottom blank area.

In an embodiment in which the bottom blank area is provided, the aerosol forming substrate 11 has a relatively short longitudinal extension length, so that a far end of the aerosol forming substrate 11 does not extend into the cavity defined by the tubular body 21 corresponding to the bottom blank area, that is, the far end of the aerosol forming substrate 11 is surrounded by the heating area 26. In addition, oil that leaks out from the aerosol forming substrate 11 under high-temperature baking of the heating area 26 flows along an inner wall of the tubular body 21 corresponding to the bottom blank area under the effect of gravity. In this way, the tubular body 21 corresponding to the bottom blank area prolongs a path for the oil to overflow the tubular body 21, which helps the oil to be retained on the inner wall of the tubular body 21 of the corresponding area. In addition, the tubular body 21 corresponding to the bottom blank area has a relatively high temperature after the tubular body 21 absorbs heat of the heating area 26, and the temperature helps the oil to be evaporated or vaporized, so that an amount of the oil retained on the inner wall of the tubular body 21 of the corresponding area can be reduced. Therefore, the tubular body 21 corresponding to the bottom blank area can reduce leakage of oil that leaks out from the aerosol forming substrate 11.

In another embodiment in which the bottom blank area is provided, the aerosol forming substrate 11 includes a bottom interval. A far end of the bottom interval is flush with a far end of the aerosol forming substrate 11, a longitudinal length between a near end of the bottom interval and the far end of the aerosol forming substrate 11 ranges from 1 mm to 12 mm, and a longitudinal length of the bottom interval of the aerosol forming substrate 11 is less than a longitudinal length of the bottom blank area. In this way, the far end of the aerosol generation product 1 is arranged above the far end of the tubular body 21, the bottom blank area partially surrounds the bottom interval of the aerosol forming substrate 11, and the bottom blank area is partially vacant, in which no aerosol forming substrate 11 exists. Therefore, one part of the bottom blank area may be used for baking the bottom interval of the aerosol forming substrate 11 inside the bottom blank area at a low temperature or slowly, and the bottom interval surrounded by the bottom blank area may further absorb oil that leaks out from the aerosol forming substrate 11 surrounded by the heating area 26; and the other part of the bottom blank area may be used for retaining or evaporating or vaporizing the oil that leaks out from the aerosol forming substrate 11 at a high temperature and that diffuses to the area.

In another embodiment in which the bottom blank area is provided, a longitudinal length of a bottom interval of the aerosol forming substrate 11 is greater than a longitudinal length of the bottom blank area. In this way, a part of the bottom interval of the aerosol forming substrate 11 extends out of the far end of the tubular body 21, and is located below the far end of the tubular body 21 in a longitudinal direction, so that the bottom interval of the aerosol forming substrate 11 is partially located outside the tubular body 21. In this way, the bottom interval of the aerosol forming substrate 11 located outside the tubular body 21 is hardly baked by the tubular body 21, so that oil does not leak out from the part of the bottom interval, and oil that overflows downward from a baked interval of the aerosol forming substrate 11 can also be absorbed, thereby helping to prevent the oil from polluting the tubular body 21. The bottom interval of the aerosol forming substrate 11 surrounded by the bottom blank area may be baked by the corresponding tubular body 21 at a low temperature or slowly, or may be baked by heat diffused from the heating area at a low temperature or slowly, which may absorb oil that leaks out from the aerosol forming substrate 11 baked by the heating area at a high temperature.

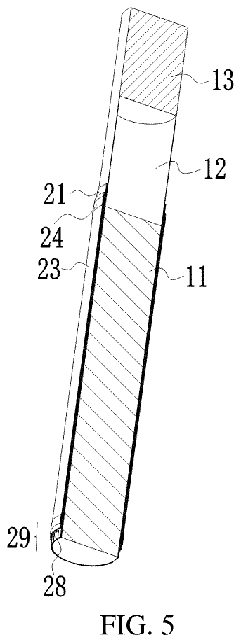

In another embodiment in which the bottom blank area is provided, referring to FIG. 2 and FIG. 5, a far end of the bottom blank area may be flush with a far end of the aerosol forming substrate 11, a bottom interval of the aerosol forming substrate 11 is completely surrounded by the bottom blank area, and longitudinal lengths of the bottom interval of the aerosol forming substrate 11 and the bottom blank area range from 1 mm to 12 mm. If the longitudinal length is excessively long, the far end of the aerosol forming substrate 11 cannot be sufficiently baked, resulting in a waste. If the longitudinal length is excessively short, the aerosol forming substrate 11 in the bottom interval may be baked by the heating area adjacent to the aerosol forming substrate 11 to cause oil to leak out. Alternatively, due to an excessively short longitudinal length, oil that leaks out from the aerosol forming substrate 11 surrounded by the heating area cannot be absorbed and locked. The longitudinal length ranging from 1 mm to 12 mm is a suitable length. Compared with the heating area, the bottom blank area can be used for heating the bottom interval of the aerosol forming substrate 11 at a low temperature or slowly, which helps to reduce oil baked out from the bottom interval of the aerosol forming substrate 11; and the bottom interval of the aerosol forming substrate 11 can also absorb the oil that leaks out from the aerosol forming substrate 11 corresponding to the heating area. Therefore, the oil can be prevented from leaking out of the tubular body 21.

In conclusion, the bottom blank area is provided, which can reduce oil that leaks out from the aerosol forming substrate 11 or reduce oil that leaks out of the cavity in the tubular body 21, thereby helping to reduce greasy dirt in the aerosol generation device.

In an embodiment, the tubular body 21 is integrally formed by a same material. In this case, materials of the tubular body 21 corresponding to the blank area 29 and the tubular body 21 corresponding to the heating area 26 are the same, and may be a metal, a ceramic, or the like. In an embodiment, the tubular body 21 includes at least one first tubular body 212 and at least one second tubular body 213, the heating area 26 is located on the first tubular body 212, the blank area 29 is located on the second tubular body 213, and the first tubular body 212 and the second tubular body 213 are separately formed. The first tubular body 212 and the second tubular body 213 may include different materials. The second tubular body 213 may be specifically as follows:

In an example, the second tubular body 213 includes a heat conducting material. As used in this specification, the term “heat conduction” refers to a material whose heat conduction at 23° C. and 50% of relative humidity is at least 10 W/mK, preferably at least 40 W/mK, and more preferably at least 100 W/mK. Specifically, the second tubular body is formed by a material whose heat conduction at 23° C. and 50% of relative humidity is at least 40 W/mK, preferably at least 100 W/mK, more preferably at least 150 W/mK, and most preferably at least 200 W/mK. This helps the first tubular body 212 to transfer heat to the second tubular body 213, thereby helping the second tubular body 213 to heat up relatively quickly. When a cavity defined by the second tubular body 213 is provided with the aerosol forming substrate 11, compared with the heating area 26, the second tubular body 213 may heat the aerosol forming substrate 11 at a low temperature or slowly heat the aerosol forming substrate 11.

In another example, the second tubular body 213 may be formed by a heat storage material. As used in this specification, the term “heat storage material” refers to a material with a high heat capacity. Through this arrangement, the second tubular body 213 may serve as a heat storage device, and may absorb heat from the first tubular body 212 and store the heat, and continuously release the heat to the aerosol forming substrate 11 over time. When a cavity defined by the second tubular body 213 is provided with the aerosol forming substrate 11, compared with the heating area 26, the second tubular body 213 may heat the aerosol forming substrate 11 at a low temperature or slowly heat the aerosol forming substrate 11. Specifically, the second tubular body 213 is formed by a material whose specific heat capacity at 25° C. and a constant pressure is at least 0.5 J/gK, preferably at least 0.7 J/gK, and more preferably at least 0.8 J/gK.

In another example, the second tubular body 213 may be heat-insulated. As used in this specification, the term “heat insulation” means that heat conduction of a material at 23° C. and 50% of relative humidity is less than 100 W/mK, and preferably less than 40 W/mK or less than 10 W/mK. Therefore, the second tubular body 213 can preserve heat of the aerosol forming substrate 11. In a process in which the first tubular body 212 heats the aerosol forming substrate 11, a part of heat is transferred with an airflow in the aerosol forming substrate 11 or by a part of the aerosol forming substrate 11 to the aerosol forming substrate 11 surrounded by the second tubular body 123. The second tubular body 213 can prevent the part of heat from being lost, so that the part of heat is fully used. When a cavity defined by the second tubular body 213 is provided with the aerosol forming substrate 11, compared with the heating area 26, the aerosol forming substrate 11 surrounded by the second tubular body 213 may be heated at a low temperature or slowly.

In another example, the second tubular body 213 may be formed by one or more materials, for example, including at least two of a heat conducting material, a heat storage material, and a heat insulating material.

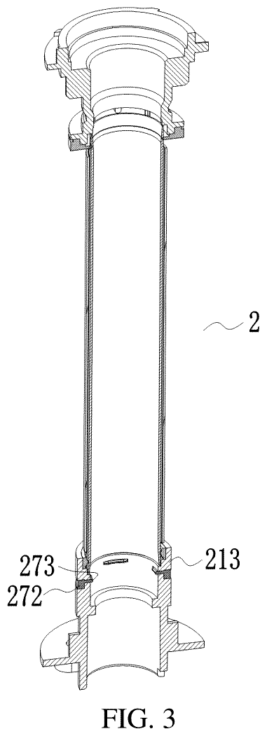

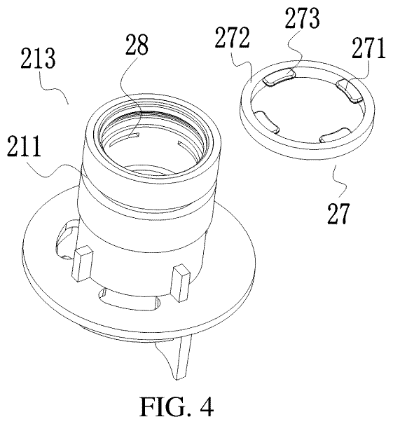

Because the first tubular body 212 and the second tubular body 213 are separately formed, during assembly of the complete tubular body 21, the first tubular body 212 and the second tubular body 213 may be spaced apart from each other and have no contact with each other. In other embodiments, referring to FIG. 2 to FIG. 4, the first tubular body 212 and the second tubular body 213 adjacent to each other may be partially nested to implement a connection. It may be understood that, the first tubular body 212 and the second tubular body 213 adjacent to each other may alternatively be connected to each other in other manners except nesting.

Based on any one of the foregoing embodiments, the tubular body 21 or the first tubular body 212 may be a metal tube. In an embodiment, the tubular body 21 or the first tubular body 212 includes a metal tube whose side wall has no joint, and the metal tube whose side wall has no joint may be prepared by using a process such as tube drawing. In another embodiment, the tubular body 21 or the first tubular body 212 includes a metal tube formed by wrapping a metal sheet. Because the metal tube is formed by wrapping the metal sheet, a side wall of the metal tube has a joint or a welding line. The metal tube has an ultra-thin side wall, and a wall thickness of the metal tube is not greater than 1 mm. Further, the wall thickness of the metal tube may be not greater than 0.3 mm. More further, the wall thickness of the metal tube may be not greater than 0.15 mm. More specifically, the wall thickness of the metal tube ranges from 0.03 mm to 0.15 mm. In an embodiment, the wall thickness of the metal tube is about 0.12 mm, to further reduce energy consumption caused by the tubular body 21.

Alternatively, the tubular body 21 or the first tubular body 212 may be a ceramic tube. The ceramic tube may be a dense ceramic, which can prevent air and liquid from passing through a side wall of the ceramic tube. In an embodiment, a wall thickness of the ceramic tube is less than 1.2 mm after the ceramic tube is thinned. More specifically, the wall thickness of the ceramic tube is less than 0.25 mm. In an embodiment, the wall thickness of the ceramic tube is 0.2 mm. The ceramic tube includes zirconium oxide. Therefore, the wall thickness of the ceramic tube is thinned, which can reduce a heat loss caused to the heating assembly 2, and also helps to improve efficiency of transferring heat from the heating element 23 to the aerosol forming substrate 11. In a specific embodiment, the tubular body 21 or the first tubular body 212 is a ceramic tube whose side wall has no joint.

In the heating assembly 2 provided in another embodiment of this application, one or more blank areas 29 are provided, and the aerosol forming substrate 11 corresponding to at least one blank area 29 is clamped, so that the aerosol forming substrate 11 can be retained in the cavity. In an embodiment, the blank area 29 may directly clamp the aerosol forming substrate 11. In another embodiment, the blank area 29 may cooperate with a clamping member to clamp the aerosol forming substrate 11, so that the blank area 29 indirectly clamps the aerosol forming substrate 11. Compared with that the aerosol generation product 1 is clamped at the insertion port 3 of the aerosol generation device or clamped between the insertion port 3 and the heating assembly 2, the aerosol forming substrate 11 is clamped in the cavity of the heating assembly 2, which helps to reduce resistance before the aerosol forming substrate 11 enters the cavity, helps the aerosol forming substrate 11 to smoothly enter the cavity, and prevents the aerosol forming substrate 11 from being twisted or bent.

Based on this, in an optional embodiment, an inner diameter of at least a part of the blank area 29 is less than an outer diameter of the aerosol forming substrate 11, or an inner wall of a part of the tubular body 21 corresponding to the blank area 29 is provided with a protrusion, so that at least a part of the blank area 29 presses the aerosol forming substrate 11 transversely inward, thereby increasing an insertion force between the aerosol forming substrate 11 and the tubular body 21 corresponding to the blank area, and retaining the aerosol forming substrate 11 in the cavity. In addition, the blank area 29 belongs to an area outside the heating area 26, and a temperature, a temperature rising speed, or the like of the blank area 29 is lower or slower than that of the heating area 26, so that the aerosol forming substrate 11 in the corresponding area can be prevented from being burned when the blank area 29 is tightly connected to the aerosol forming substrate 11.

In a specific embodiment, only an inner diameter of at least a part of a blank area located at the lowest is less than the outer diameter of the aerosol forming substrate 11, or an inner wall of a part of the tubular body 21 corresponding to the blank area 29 located at the lowest is provided with a protrusion, so that the bottom interval of the aerosol forming substrate 11 is clamped. An inner diameter of another area of the tubular body 21 is not less than the outer diameter of the aerosol generation product 1, thereby helping the aerosol forming substrate 11 to smoothly move from the near end of the tubular body 21 to the far end of the tubular body 21. Finally, the bottom interval of the aerosol forming substrate 11 is clamped due to interference of force with the blank area 29.

A longitudinal distance between the far end of the aerosol forming substrate 11 and a location at which the aerosol forming substrate 11 is clamped may range from 1 mm to 4 mm, for example, the longitudinal distance is about 2.2 mm.

More specifically, the lowest blank area 29 may be the bottom blank area described in any one of the foregoing embodiments.

In another optional embodiment, the heating assembly 2 further includes a clamping member 27, the corresponding blank area 29 is provided with a first notch 28, and the clamping member 27 at least partially passes through the first notch 28 and enters the cavity, to clamp the aerosol forming substrate 11. The clamping member 27 may be arranged outside the tubular body 21, and is fixed to the aerosol generation device outside the heating assembly 2, for example, is fixed to a heat insulating member outside the heating assembly 2. In another embodiment, the clamping member 27 may be fixed to the periphery of the tubular body 21.

The clamping member 27 may elastically clamp the aerosol generation product 1. When the aerosol generation product 1 comes into contact with the clamping member 27, the clamping member 27 may be elastically deformed, to clamp the aerosol generation product 1 well and stably, and prevent the aerosol generation product 1 from being accidentally carried out of the aerosol generation device by the user due to sticking of the mouthpiece 13 to the mouth when the aerosol generation product 1 is held by the user. Specifically, the clamping member 27 may be made of a flexible material, for example, silica gel.

The clamping member 27 may be provided with an inclined guiding surface 271, and the inclined guiding surface 271 is arranged toward the near end of the tubular body 21. In a process in which the aerosol generation product 1 moves toward a far end of the cavity, the aerosol generation product 1 comes into contact with at least a part of the inclined guiding surface 271. The inclined guiding surface 271 may guide the aerosol generation product 1 to move, which can reduce resistance when the aerosol generation product 1 further enters the cavity. The inclined guiding surface 271 is helpful for the aerosol generation product 1 to smoothly reach the far end of the cavity.

Further, at least a part of the tubular body 21 is a metal base, and the first notch 28 is formed on the metal base. The first notch 28 is easier to be formed on the metal base than a ceramic.

Referring to FIG. 2, the clamping member 27 is configured to clamp the bottom interval of the aerosol forming substrate 11, to reduce resistance before the aerosol forming substrate 11 enters the bottom of the cavity, and ensure that the aerosol forming substrate 11 can smoothly enter the bottom of the cavity.

Specifically, a longitudinal distance L1 between the clamping member 27 and the far end of the tubular body 21 or the far end of the aerosol forming substrate 11 ranges from 1 mm to 4 mm, for example, the longitudinal distance L1 is about 2.2 mm. The longitudinal distance L1 between the clamping member 27 and the far end of the aerosol forming substrate 11 is less than the longitudinal length of the bottom interval of the aerosol forming substrate 11. The longitudinal length of the bottom interval of the aerosol forming substrate 11 may range from 1 mm to 12 mm. In still another embodiment, the tubular body includes at least one first tubular body 212 and at least one second tubular body 213, the first tubular body 212 may be the same as the first tubular body 212 described in any one of the foregoing embodiments, and the second tubular body 213 may be the same as the second tubular body 213 described in any one of the foregoing embodiments. The first tubular body 212 is located in the heating area, the second tubular body 213 is located in the blank area 29, and the second tubular body 213 may be made of an insulating material such as a plastic piece or a ceramic. At least one second tubular body 213 clamps the aerosol forming substrate 11.

In a further embodiment, a clamping member 27 is provided on at least one second tubular body 213, and the clamping member 27 at least partially protrudes into the cavity, to clamp the aerosol forming substrate 11, thereby retaining the aerosol forming substrate 11. The clamping member 27 may have a plurality of forms. For example, the clamping member 27 may be a protrusion, a spring, or the like formed on an inner wall of the second tubular body 213, to press the aerosol forming substrate 11 through abutment or elastic abutment.

In another further embodiment, the heating assembly 2 further includes a clamping member 27, at least one second tubular body 213 is provided with a first notch 28, the clamping member 27 includes a fixing portion 272 and a protruding portion 273, the fixing portion 272 surrounds the second tubular body 213 and is supported by the second tubular body 213, and the protruding portion 273 passes through the first notch 28 and enters the cavity, to clamp the aerosol forming substrate 11, thereby retaining the aerosol forming substrate 11.

Specifically, the fixing portion 272 may be annular and has elasticity, to be sleeved on the second tubular body 213; and the fixing portion 272 and the second tubular body 213 are tightly connected to each other by using an elastic contraction force, and are fixed to each other. To precisely position the clamping member 27, or to prevent the fixing portion 272 from displacing relative to the second tubular body 213, a positioning groove 211 is arranged at a periphery of the second tubular body 213, and the fixing portion 272 is embedded in the positioning groove 211. One end of the protruding portion 273 is connected to the fixing portion 272, and the other end of the protruding portion 273 can pass through the first notch 28, to extend into the cavity, so that the aerosol forming substrate 11 can be clamped. A radial length by which the protruding portion 273 enters the cavity after passing through the first notch 28 may range from 0.05 mm to 0.5 mm. The inclined guiding surface 271 described in any one of the foregoing embodiments may be arranged on the protruding portion 273. The protruding portion 273 is elastically deformed when being pressed by the aerosol forming substrate 11.

Still further, a longitudinal length between the protruding portion 272 and the far end of the aerosol forming substrate 11 ranges from 1 mm to 4 mm, for example, may be 2.2 mm. The clamping member 27 and a heating area 26 closest to the clamping member 27 are spaced apart from each other, to prevent the heating area 26 from damaging or aging the clamping member 27 at a high temperature.

In a still further embodiment, referring to FIG. 2, a second tubular body 213 may include a bottom wall, and the bottom wall extends in a radial direction of the cavity and defines the bottom of the cavity. The bottom wall forms a stop, to prevent the aerosol generation product 1 from passing out of the cavity from below.

Still further, an air inlet is provided on the bottom wall, and air enters the cavity through the air inlet.

In the heating assembly 2 provided in another embodiment of this application, the heating element includes a heating film layer, the heating film layer includes a layer formed by a resistance material, an infrared electrothermal coating, or the like, and the heating film layer may include one or more sheet heating film layers, one or more heating track film layers, or the like. The heating film layer may be coated in the heating area 26. The coating manner may include a printing technology, a spraying technology, a PVD coating technology, an electroplating technology, or the like. The at least one blank area 29 described in any one of the foregoing embodiments is provided with a retaining location. The retaining location is used for combining with a rotating jig, so that the tubular body 21 or the first tubular body 212 rotates with a jig 4, to coat the heating element 23 on the tubular body 21 or the first tubular body 212.

When the tubular body 21 or the first tubular body 212 is a tube (including a metal tube, a ceramic tube, or the like), the heating element 23 may be formed in the heating area 26 by using a curved surface coating technology. When the curved surface coating technology is used, the retaining location on the tubular body 21 or the first tubular body 212 needs to be combined with the jig 4.

In an embodiment, the jig 4 is connected to a rotation electric machine, a rotation motor, a rotation air cylinder, or the like, and is fixedly combined with the retaining location. Under a combination action force, the tubular body 21 or the first tubular body 212 may rotate with the jig 4. In the process in which the tubular body 21 or the first tubular body 212 rotates, a coating head configured to coat the heating film layer performs coating, to form the heating element 23 in the heating area 26. In another embodiment, the tubular body 21 or the first tubular body 212 is fixed by using the jig 4, so that a coating head rotates around the tubular body 21 or the first tubular body 212, to form the heating element 23 in the heating area 26.

Specifically, a coating thickness of the heating film layer may range from 0.01 mm to 0.05 mm. In a more specific embodiment, a coating thickness of the heating element 23 ranges from about 0.012 mm to about 0.022 mm.

In an embodiment, this application further provides a jig 4, configured to engage with the tubular body 21 or the first tubular body 212 described in any one of the foregoing embodiments, so that the tubular body 21 or the first tubular body 212 rotates or keeps still during coating.

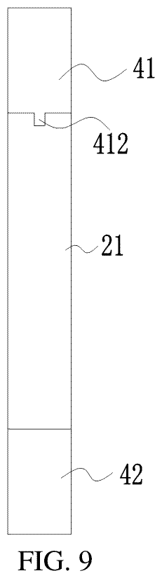

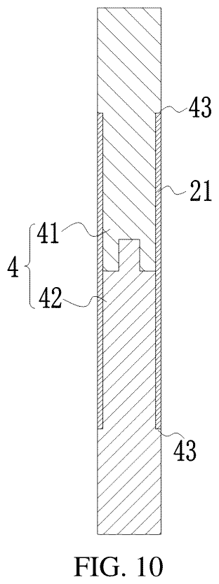

Referring to FIG. 9 and FIG. 10, the jig 4 may include a first support portion 41 and a second support portion 42. The first support portion 41 and the second support portion 42 are respectively inserted into the cavity from the near end and the far end of the tubular body 21 or the first tubular body 212, so that a side wall of the tubular body 21 or the first tubular body 212 can be supported. Particularly, when the tubular body 21 or the first tubular body 212 is made of a thin-walled metal tube and a wall thickness ranges from 0.05 mm to 0.08 mm, the first support portion 41 and the second support portion 42 support a side wall of the thin-walled metal tube, which can prevent the side wall of the thin-walled metal tube from being deformed during coating, thereby helping the side wall of the thin-walled metal tube to maintain good consistency.

The first support portion 41 and the second support portion 42 are connected to each other. The first support portion 41 and the second support portion 42 may be detachably connected to each other, for example, the first support portion 41 and the second support portion 42 may be detachably connected through threading. Specifically, when the first support portion 41 and the second support portion 42 are inserted into the cavity from two opposite ends of the tubular body 21 or the first tubular body 212, the first support portion 41 and/or the second support portion 42 rotates, so that the first support portion 41 and the second support portion 42 are detachably connected inside the tubular body 21 or the first tubular body 212.

In a further embodiment, a stop portion 43 is arranged on at least one of the first support portion 41 and the second support portion 42. The stop portion 43 is configured to abut against an end portion of the tubular body 21 or the first tubular body 212, to prevent the first support portion 41 and the second support portion 42 from excessively entering the tubular body 21 or the first tubular body 212, so that parts of the first support portion 41 and the second support portion 42 are remained outside the tubular body 21 or the first tubular body 212. The parts remained outside the tubular body 21 or the first tubular body 212 are defined as connecting handles. At least one of the connecting handles is configured to connect to a rotation device such as the rotation electric machine, the rotation motor, or the rotation cylinder. The connecting handle is driven to rotate by using the rotation device, so that the first support portion 41 and the second support portion 42 drive the tubular body 21 or the first tubular body 212 to rotate.

In a more further embodiment, a connecting handle of the first support portion 41 is a first connecting handle 421, and a connecting handle of the second support portion 42 is a second connecting handle 421. The first connecting handle 411 is configured to connect to the rotation device, and the second connecting handle 421 is vacant, to ensure that the first support portion 411 and the second support portion 421 have a same rotational speed.

In a still further embodiment, the first connecting handle 411 of the first support portion 41 cooperates with the retaining location on the tubular body 21 or the first tubular body 212. In an embodiment, the retaining location is the first notch 28, a through hole, or a groove. In this case, a convex tooth 412 is provided on the first support portion 41, and the convex tooth 412 may be stuck in the first notch 28, the through hole, or the groove, so that when the first support portion 41 rotates, the tubular body 21 or the first tubular body 212 is driven to synchronously rotate, thereby avoiding inconsistent rotation speeds due to slippage. In an embodiment, the retaining location is a rib. In this case, a break is provided on the first support portion, and the rib may be stuck in the break, so that when the first support portion rotates, the tubular body or the first tubular body is driven to synchronously rotate.

In still further another embodiment, the first connecting handle 411 of the first support portion 41 is connected to the tubular body 21 or the first tubular body 212 through snapping, the second support portion 42 is connected to the first support portion 41 inside the tubular body 21 or the first tubular body 212 through threading, and there is no snapping between the second support portion 42 and the tubular body 21 or the first tubular body 212.

In still further another embodiment, outer diameters of the first support portion 41 and the second support portion 42 are equal to an inner diameter of the tubular body 21 or the first tubular body 212.

It may be understood that, in some embodiments, the first support portion and the second support portion may be an integrally formed structure, which may penetrate from one end of the tubular body or the first tubular body, and then may partially penetrate out of the other end of the tubular body or the first tubular body, or may be flush with the other end of the tubular body or the first tubular body.

When the tubular body 21 or the first tubular body 212 is the metal tube, at least one insulating layer 22 may be formed on an outer surface of the metal tube by using a process such as coating, and the heating element 23 (including a coating or non-coating heating element) is arranged on an insulating layer 22 of the corresponding heating area. The insulating layer 22 is configured to insulate the heating element 23 from the metal tube. The insulating layer 22 may be coated by using the foregoing coating process. It may be understood that, in another embodiment, the insulating layer 22 may include a metal oxide layer formed by oxidation of a metal in a high-temperature environment. Therefore, the insulating layer 22 may not be coated on a surface of the metal tube. In another embodiment, the insulating layer 22 may be an insulating sleeve arranged on an outer surface of the metal tube. In still another embodiment, the insulating layer 22 may be formed on the surface of the metal tube through anodization.

In a specific embodiment, a thickness of the insulating layer 22 may range from 0.01 mm to 0.05 mm. In a more specific embodiment, the thickness of the insulating layer 22 ranges from about 0.012 mm to about 0.022 mm.

When the heating element 23 includes the heating film layer, the electrode 24 (an electrode film layer) electrically connected to the heating element 23 may also be formed on the tubular body 21 or the first tubular body 212 by using the foregoing coating process, or may be coated on the insulating layer 22 of the metal tube.

Specifically, a coating thickness of the electrode 24 (the electrode film layer) may range from 0.01 mm to 0.05 mm. More specifically, the coating thickness of the electrode 24 (the electrode film layer) ranges from about 0.012 mm to about 0.022 mm.

Optionally, when the tubular body 21 is the metal tube, any one of the foregoing bottom blank areas may be further limited between a far end of the insulating layer 22 and the far end of the tubular body 23, that is, the insulating layer 22 may not be coated in the bottom blank area. In another example, an insulating layer is also provided on a metal tube corresponding to the bottom blank area.

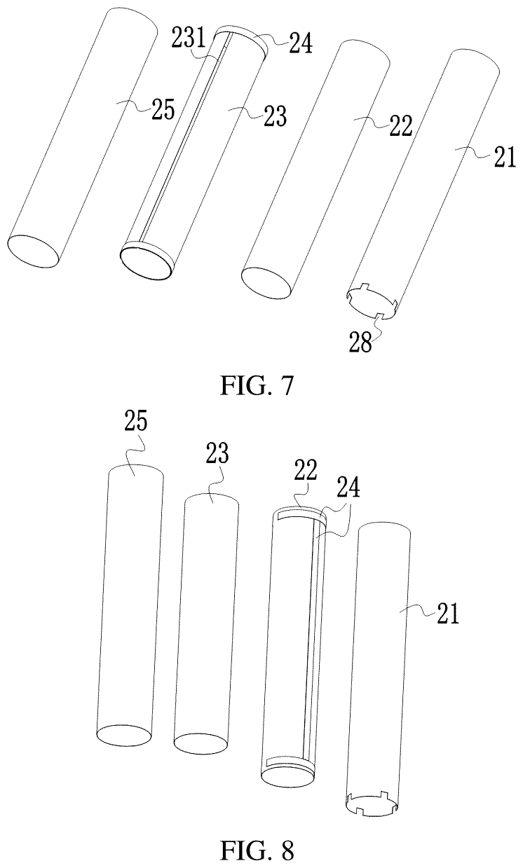

Referring to FIG. 7 and FIG. 8, a protective layer 25 may be further provided on the periphery of the tubular body 21 or the first tubular body 212, to protect the heating element 23 and the electrode 24. The electrode 24 may be partially exposed outside the protective layer 25, to be electrically connected to the lead wire or the conduction terminal electrically connected to the power supply. The protective layer 25 may also be formed on the periphery of the tubular body 21 or the first tubular body 212 by using the foregoing coating process.

Specifically, a thickness of the protective layer 25 may range from 0.01 mm to 0.05 mm. More specifically, the thickness of the coating of the protective layer 25 ranges from about 0.012 mm to about 0.022 mm.

In the heating assembly 2 provided in still another embodiment of this application, the at least one blank area 29 described in any one of the foregoing embodiments is provided with a positioning portion, and the positioning portion forms reference coordinates, and is used for determining a boundary of at least a part of the heating element 23.

Based on this, in an embodiment, referring to FIG. 8, the heating element 23 may surround the heating area 26 360°, so that the heating element 23 at least partially forms a closed ring. The positioning portion may be used as a reference point, to determine a location at which the heating element 23 is arranged on the tubular body 21, so that the location at which the heating element 23 is arranged on the tubular body 21 is related to the positioning portion.

In another embodiment, referring to FIG. 6 and FIG. 7, the heating element 23 may include a heating film layer. The heating film layer extends in a circumferential direction of the tubular body 21 or the first tubular body 212, and is provided with a second notch 231. The second notch 231 causes the heating element 23 to be disconnected, so that a closed ring is not formed. Alternatively, the second notch 231 causes the heating element 23 to at least partially lose continuity. In an embodiment, the second notch 231 may be formed by removing a film layer of a part of the heating element 23. For example, a part of a closed ring-shaped heating element 23 is removed, so that the heating element 23 forms an unclosed ring, and an unclosed part forms the second notch 231. In other words, the second notch 231 may be formed by using a film removing process (where one of film removing processes is to remove a coating with a specified thickness by using a laser etching method). In another embodiment, the second notch 231 is formed by termination of coating. For example, in two opposite side edges of the second notch 231, one side edge is a coating start edge, the other side edge is a coating end edge, and a coating start point does not overlap with a coating end point. In a curved surface coating process, an angle by which the tubular body 21 or the first tubular body 212 rotates relative to the coating head may be less than 360°, to form the second notch 231. In another embodiment, the second notch 231 is formed by discontinuity of coating. The coating head jumps when coating to a location, so that the heating film layer is not coated on the location, and a vacancy, namely, the second notch 231, is formed.

In the embodiments shown in FIG. 6 and FIG. 7, a current longitudinally flows on the heating film layer, and the second notch 231 longitudinally extends and is line-shaped, so that the corresponding heating film layer is about C-shaped. It may be understood that, in some embodiments, one or more second notches 231 may be provided. The second notch 231 may be a shape such as a circle, a triangle, or a square. The second notch 231 may be surrounded by the heating film layer, and may be sequentially or randomly distributed on the tubular body 21. In an embodiment, a plurality of second notches 231 may cause the heating film layer to form a mesh.

Through arrangement of the second notch, resistance of the heating film layer may be adjusted, or temperature field distribution on the tubular body 21 may be adjusted, to adapt to more heating requirements.

In an embodiment, the positioning portion is used for positioning a boundary of at least a part of the heating element 23, so that a location and a size of the at least a part of the heating element 23 are controllable, thereby facilitating processing, and helping to improve production efficiency.

Specifically, the positioning portion may be a structure such as a rib, a groove, a first notch, or a through hole. The positioning portion such as the first notch 28 may form a reference point. A coordinate or a boundary of an edge of the second notch 231 on the tubular body 21 is determined based on one or more reference points. For example, a start edge and an end edge during a film removing process are determined, or a start edge and an end edge during coating are determined, or a jumping point and a landing point during coating are determined. In this way, a boundary of the heating element 23 in the heating area 26 and a boundary of the heating element 23 under the second notch 231 may be determined according to the positioning portion, thereby facilitating standardized mass production of heating assemblies 2 with a same specification.

It may be understood that, the foregoing retaining location and the foregoing positioning portion may be replaced with each other, or may be a same member.

It may be understood that, in an embodiment, the retaining location or the positioning portion is located outside the heating area 26 on the tubular body 21 or the first tubular body 212, and the retaining location or the positioning portion on the tubular body 21 or the first tubular body 212 may be remained after a coating and/or film removing work is entirely completed. In an embodiment, the aerosol generation device includes a receiving cavity and a mounting base. The remained retaining location or positioning portion may cooperate with the mounting base, to be positioned on the mounting base, and be retained in the receiving cavity by using the mounting base. In an embodiment, the remained retaining location or positioning portion is the first notch described in any one of the foregoing embodiments, and is used for allowing the clamping member 27 to clamp the aerosol forming substrate 11.

In another embodiment, the retaining location or the positioning portion is located on the top blank area or the bottom blank area on the tubular body 21 or the first tubular body 212. After the coating and/or film removing work is entirely completed, an area on the tubular body 21 or the first tubular body 212 in which the retaining location or the positioning portion is located may be removed, to remove the retaining location or the positioning portion. Particularly, when the tubular body 21 or the first tubular body 212 is the metal tube, the blank area 29 provided with the retaining location or the positioning portion may be removed by using a cutting technology.

Based on this, in an embodiment, when the tubular body 21 includes both the top blank area and the bottom blank area, the longitudinal extension length of the top blank area may be different from the longitudinal extension length of the bottom blank area. For example, if the foregoing retaining location or positioning portion is arranged in the bottom blank area and the foregoing retaining location or positioning portion is not arranged in the top blank area, the longitudinal extension length of the top blank area may be less than the longitudinal extension length of the bottom blank area. If a part of the bottom blank area may be cut, the retaining location or the positioning portion may be arranged on the part that can be cut. After the bottom blank area is cut, the top blank area and the remaining bottom blank area may have a same longitudinal length. In another embodiment, referring to FIG. 5, the tubular body 21 may include both the top blank area and the bottom blank area, the longitudinal extension length of the top blank area is the same as the longitudinal extension length of the bottom blank area, and the foregoing retaining location or positioning portion or first notch described in any one of the foregoing embodiments is arranged in the bottom blank area, where the retaining location, the positioning portion, and the first notch are of an integral structure.

It should be noted that, the retaining location or the positioning portion or the first notch is arranged in the top blank area or the bottom blank area on the tubular body 21 or the first tubular body 212. However, the retaining location or the positioning portion or the first notch may not damage integrity of the electrode 24, that is, the retaining location or the positioning portion or the first notch may be arranged to avoid the electrode 24. Preferably, a spacing may be provided between the retaining location or the positioning portion or the first notch and the electrode 24, where the spacing may range from 0.1 mm to 3 mm.

Based on any one of the foregoing embodiments, a ratio of a longitudinal extension length of the heating area 26 to a longitudinal extension length of the aerosol forming substrate ranges from 0.6 to 1.1. When the length ratio ranges from 0.6 to 1, energy consumption of the heating assembly 2 can be reduced. When the length ratio ranges from 1 to 1.1, (1) the heating element 23 completely surrounds the periphery of the aerosol forming substrate 11, or (2) the near end of the heating element 23 is closer to the mouthpiece 13 than the near end of the aerosol forming substrate 11, or (3) the far end of the heating element 23 is farther from the mouthpiece 13 than the far end of the aerosol forming substrate 11. (1) and (2) help to improve a rate of forming an aerosol, and help to shorten time for the user to wait for inhalation for the first time. In addition, in (3), when oil in the aerosol forming substrate 11 leaks out at a high temperature, flows downward, and flows through the heating area 26 in which the heating element 23 outside the far end of the aerosol forming substrate 11 is located, the oil may be vaporized by the heating element 23, so that greasy dirt in the aerosol generation device can be reduced.

According to the foregoing heating assembly and aerosol generation device provided in this application, a far end of a heating area and a far end of a tubular body are spaced apart from each other, and a blank area is at least partially located between the far end of the heating area and the far end of the tubular body, so that a far end of an aerosol forming substrate is relatively at a relatively low ambient temperature, or oil that leaks out from the aerosol forming substrate is retained by the far end of the tubular body, thereby preventing pollution caused by oil leakage when an aerosol generation product is baked.

According to the heating assembly and the aerosol generation device provided in this application, because the blank area is provided, the heating area does not cover the entire tubular body. Based on a same material and thickness, a smaller heating area can reduce power consumption of the heating assembly. The heating assembly may clamp the aerosol forming substrate by using the blank area or a second tubular body, thereby helping the aerosol forming substrate to smoothly enter a cavity. The blank area or the second tubular body may be provided with a first notch or a retaining location or a positioning portion. In this way, the first notch or the retaining location or the positioning portion can be used for assisting a clamping member in clamping the aerosol forming substrate, and can also cooperate with a jig to cause the tubular body to rotate, to implement curved surface coating on the tubular body. In addition, the first notch or the retaining location or the positioning portion can be used as a reference point to position a coating area of a heating element or position a film removing area of the heating element.

It should be noted that, this specification of this application and the drawings thereof illustrate preferred embodiments of this application, but are not limited to the embodiments described in this specification, furthermore, a person of ordinary skill in the art may make improvements or variations according to the above descriptions, and such improvements and variations shall all fall within the protection scope of the appended claims of this application.

1. A heating assembly comprising:
a tubular body having a cavity formed therein, wherein:
a near end of the tubular body is open and is used for allowing an aerosol forming substrate in an aerosol generation product to enter the cavity; and
the tubular body has a heating area and a blank area, and at least a part of the heating area and at least a part of the blank area are arranged to surround a periphery of the aerosol forming substrate,
wherein:
a temperature and/or a temperature rising speed of the blank area is lower than a temperature and/or a temperature rising speed of the heating area; and
a near end of the heating area is closer to the near end of the tubular body than a far end of the heating area, the far end of the heating area and a far end of the tubular body are spaced apart from each other in a longitudinal direction of the tubular body, and the blank area is at least partially located between the far end of the heating area and the far end of the tubular body.

2. The heating assembly according to claim 1, wherein:
a far end of the aerosol generation product is closer to the far end of the tubular body than a near end of the aerosol forming substrate; and
the far end of the aerosol generation product is arranged below or above the far end of the tubular body, or is flush with the far end of the tubular body.

3. The heating assembly according to claim 1, wherein the heating assembly comprises a heating element, and the heating element is formed on a part of the tubular body and defines a boundary of the heating area; and compared with the heating area, the blank area lacks at least the heating element.

4. The heating assembly according to claim 1, wherein the heating assembly comprises a heating element, the heating element comprises a heating film layer, and the heating assembly further comprises an electrode film layer; and the heating film layer and the electrode film layer are formed on the tubular body in an overlapping manner, and an overlapping location defines at least a near end of at least a part of the blank area.

5. The heating assembly according to claim 3, wherein materials of the tubular body in the heating area and the tubular body in the blank area are different.

6. (canceled)

7. The heating assembly according to claim 1, wherein a ratio of a longitudinal extension length of the heating area to a longitudinal extension length of the aerosol forming substrate ranges from 0.6 to 1.1.

8. The heating assembly according to claim 1, wherein a longitudinal spacing between the far end of the heating area and the far end of the tubular body ranges from 1 mm to 12 mm.

9. The heating assembly according to claim 1, wherein an inner wall of the blank area at least directly or indirectly clamps a part of the aerosol generation product.

10. The heating assembly according to claim 9, wherein the heating assembly further comprises a clamping member sleeved outside the tubular body, the blank area is provided with a notch, and the clamping member at least partially passes through the notch and enters the cavity, to clamp the aerosol forming substrate.

11. The heating assembly according to claim 1, wherein a part of the tubular body located in the blank area comprises a metal material on which insulation processing has been performed.

12. The heating assembly according to claim 1, wherein the blank area comprises a retaining location, used for clamping the tubular body during processing of the heating assembly.

13. The heating assembly according to claim 1, wherein the blank area is provided with a positioning portion, used for determining a boundary of at least a part of a heating element.

14. (canceled)

15. The heating assembly according to claim 13, wherein:
the heating assembly comprises the heating element, the heating element comprises a heating film layer extending in a circumferential direction of the tubular body, and the heating film layer is provided with a notch to form an unclosed ring; and
a location of the notch is related to the positioning portion.

16. A heating assembly comprising:
a tubular body, having a cavity formed therein, wherein a near end of the tubular body is open and is used for allowing a part of an aerosol generation product to enter the cavity, and the tubular body comprises a heating area and a blank area; and
a heating element, at least partially arranged in the heating area, and configured to heat an aerosol forming substrate in the aerosol generation product, to generate an aerosol, wherein the aerosol forming substrate enters the heating area from a near end of the heating area;
wherein:
a temperature of the blank area is lower than a temperature of the heating area, or a temperature rising speed of the blank area is lower than a temperature rising speed of the heating area, or heating efficiency of the blank area for the aerosol forming substrate is lower than heating efficiency of the heating area for the aerosol forming substrate; and
the blank area comprises a retaining location, used for clamping the tubular body during processing of the heating assembly.

17. The heating assembly according to claim 16, wherein the retaining location is configured to combine with a jig, to cause the tubular body to rotate with the jig, and coat the heating element on the tubular body.

18. A heating assembly comprising:
a tubular body, having a cavity formed therein, wherein a near end of the tubular body is open and is used for allowing an aerosol forming substrate in an aerosol generation product to enter the cavity; and
the tubular body has a heating area and a blank area, and the heating area is used for heating the aerosol forming substrate, to generate an aerosol,
wherein:
the aerosol forming substrate enters the heating area from a near end of the heating area; a temperature of the blank area is lower than a temperature of the heating area, or a temperature rising speed of the blank area is lower than a temperature rising speed of the heating area, or heating efficiency of the blank area for the aerosol forming substrate is lower than heating efficiency of the heating area for the aerosol forming substrate; and
at least a part of the aerosol forming substrate corresponding to the blank area is clamped.

19. The heating assembly according to claim 18, wherein:
an inner diameter of at least a part of the blank area is less than an outer diameter of the aerosol forming substrate; or
an inner wall of a part of the tubular body corresponding to the blank area is provided with a protrusion.

20. The heating assembly according to claim 19, wherein the heating assembly further comprises a clamping member, the corresponding blank area is provided with a notch, and the clamping member at least partially passes through the notch and enters the cavity, to clamp the aerosol forming substrate.

21. The heating assembly according to claim 20, wherein the clamping member comprises an elastic material, configured to elastically clamp the aerosol forming substrate; and/or
the clamping member is provided with an inclined guiding surface, and the inclined guiding surface is arranged toward the near end of the tubular body.

22. An aerosol generation device comprising a shell and the heating assembly according to claim 1, wherein an accommodating cavity is formed in the shell, and is for accommodating the heating assembly; and an insertion port is provided on the shell, and the aerosol forming substrate passes through the insertion port and then enters the cavity.
